(19) United States
(12) Patent Application Publication
(10) Pub. No.: US 2026/0066582 A1
(43) Pub. Date: Mar. 5, 2026

(54) ELECTRICAL CONNECTOR AND ELECTRICAL CONNECTOR ASSEMBLY

(71) Applicants: FOXCONN (KUNSHAN) COMPUTER CONNECTOR CO., LTD., Kunshan (CN); FOXCONN INTERCONNET TECHNOLOGY LIMITED, Grand Cayman (KY)

(72) Inventors: YANG-TSUN HSU, New Taipei (TW); Jerry Wu, Irvine, CA (US); Jun Chen, Kunshan (CN); Xiao Fan, Huaian (CN); Qi-Feng Yang, Huaian (CN)

(21) Appl. No.: 19/310,084

(22) Filed: Aug. 26, 2025

(30) Foreign Application Priority Data
Aug. 30, 2024 (CN) 202411209245.5

(51) Int. Cl. H01R 13/631; H01R 12/72; H01R 12/75

(52) U.S. Cl. CPC H01R 13/631; H01R 12/722; H01R 12/75

(57) ABSTRACT

An electrical connector includes: a cable extending along a first direction; a terminal connected to the cable; a housing including: a top portion, a bottom portion, and a first side wall and a second side wall between the top portion and the bottom portion; a cavity receiving the terminal and extending along a second direction perpendicular to the first direction, the bottom portion including an opening in fluid communication with the cavity for a mating terminal to enter the cavity through the opening and be electrically connected to the terminal; and a latch accommodating space in communication with the cavity; and a latch movably received in the latch accommodating space and configured to engage the mating terminal in a locked position and to release the mating terminal in an unlocked position; wherein the latch is unlocked and locked with the mating terminal by rotating clockwise and counterclockwise respectively.

### BACKGROUND OF THE INVENTION

### Field of the Invention

The present invention generally relates to an electrical connector and electrical connector assembly for transmitting large currents.

### Description of Related Arts

In large current transmission application scenarios, stable current transmission is crucial. To ensure the stability and safety of power transmission, it is necessary to design a locking mechanism on the connector to prevent accidents or disengagement, ensure safety and connection stability during large current transmission, and ensure the continuity of current transmission and the normal operation of the equipment.

U.S. Pat. No. 11,670,893 discloses a socket connector including a housing having a pin access opening through a bottom open to a cavity configured to receive a pin. The socket connector includes a socket in the cavity electrically connected to a pin. The socket connector includes a latch movably received in a latch pocket to engage the pin to secure the socket connector to the pin. The latch includes a latch release accessible exterior of the housing to release the latch. The latch release moves the latch between a latched position and a clearance position. A latching rib of the latch engages the pin in the latched position and is released from the pin in the clearance position to allow uncoupling of the socket connector from the pin. The latch relies on the elastic force generated by the latch arm to reset so under frequent use it may not provide sufficient stability and reliability. Therefore, an improved electrical connector is desired.

### SUMMARY OF THE INVENTION

The main object of the present invention is to provide an improved electrical connector and electrical connector assembly, wherein the electrical connector can achieve a more reliable and stable connection with its mating connector.

To achieve the above-mentioned object, an electrical connector comprises: a cable extending along a first direction; a terminal connected to the cable; a housing comprising: a top portion, a bottom portion, and a first side wall and a second side wall between the top portion and the bottom portion; a cavity for receiving the terminal and extending along a second direction perpendicular to the first direction, the bottom portion comprising an opening in fluid communication with the cavity for a mating terminal of a mating connector to enter the cavity through the opening and be electrically connected to the terminal; and a latch accommodating space in communication with the cavity; and a latch movably received in the latch accommodating space and configured to engage the mating terminal in a locked position to lock the electrical connector with the mating connector, and to release the mating terminal in an unlocked position to unlock the electrical connector from the mating connector; wherein the latch is unlocked and locked with the mating terminal by rotating clockwise and counterclockwise respectively.

To achieve the above-mentioned object, an electrical connector comprises: a cable extending along a first direction; a first terminal and a second terminal connected with the cable; a housing comprising: a top portion, a bottom portion, and a first side wall and a second side wall between the top portion and the bottom portion; a first cavity and a second cavity respectively accommodating the first terminal and the second terminal and extending along a second direction perpendicular to the first direction, the bottom portion comprising a pair of openings respectively in fluid communication with the first cavity and the second cavity for a pair of mating terminals of a mating connector to enter the first cavity and the second cavity through the pair of openings to be electrically connected to the first contact terminal and the second contact terminal; and a latch accommodating space in communication with the first cavity and the second cavity; and a latch movably received in the latch accommodating space and configured to engage the mating terminals in a locked position to lock the electrical connector with the mating connector, and to release the mating terminals in an unlocked position to unlock the electrical connector from the mating connector; wherein the latch is unlocked and locked with the mating terminals by rotating clockwise and counterclockwise respectively.

To achieve the above-mentioned object, an electrical connector assembly comprises: a board-end connector comprising a first mating terminal, a second mating terminal, and a substrate holding the first mating terminal and the second mating terminal; and a cable-end connector mating with the board-end connector comprising: a cable extending along a first direction; a first terminal and a second terminal connected to the cable; a housing comprising: a top portion, a bottom portion, and a first side wall and a second side wall between the top portion and the bottom portion; a first cavity and a second cavity respectively accommodating the first terminal and the second terminal and extending along a second direction perpendicular to the first direction, the bottom portion comprising a pair of openings respectively in fluid communication the first cavity and the second cavity, the first mating terminal and the second mating terminal respectively entering the first cavity and the second cavity through the pair of the openings to be electrically connected to the first contact terminal and the second contact terminal; and a latch accommodating space in communication with the first cavity and the second cavity; and a latch movably received in the latch accommodating space and configured to engage the first mating terminal and the second mating terminal in a locked position to lock the cable-end connector with the board-end connector, and to release the first mating terminal and the second mating terminal in an unlocked position to unlock the cable-end connector from the board-end connector; wherein the latch is unlocked and locked with the first mating terminal and the second mating terminal by rotating clockwise and counterclockwise respectively.

Compared to prior art, the electrical connector of the present invention realizes a more reliable and stable connection with its mating connector through the design of the latch structure, thereby ensuring the safety and stability of power transmission.

### BRIEF DESCRIPTION OF DRAWINGS

FIG. 1 is a perspective view of an electrical connector assembly, with a cable-end connector and a board-end connector being in a locked state;

FIG. 2 is a perspective view of the electrical connector assembly shown in FIG. 1, with the cable-end connector and the board-end connector being in an unlocked state;

FIG. 3 is a perspective view of the cable-end connector and the board-end connector;

FIG. 4 is another perspective view of the cable-end connector and the board-end connector;

FIG. 5 is a exploded view of the cable-end connector shown in FIG. 3;

FIG. 6 is another exploded view of the cable-end connector shown in FIG. 5;

FIG. 7 is a cross-sectional view of the electrical connector assembly shown in FIG. 1 taken along line A-A, wherein the latch is in the locked position;

FIG. 8 is a cross-sectional view of the electrical connector assembly shown in FIG. 2 taken along line B-B, wherein the latch is in the unlocked position;

FIG. 9 is a cross-sectional view of the electrical connector assembly shown in FIG. 1 taken along line C-C; and

FIG. 10 is a cross-sectional view of the electrical connector assembly shown in FIG. 2 taken along line D-D.

### DETAILED DESCRIPTION OF DRAWINGS

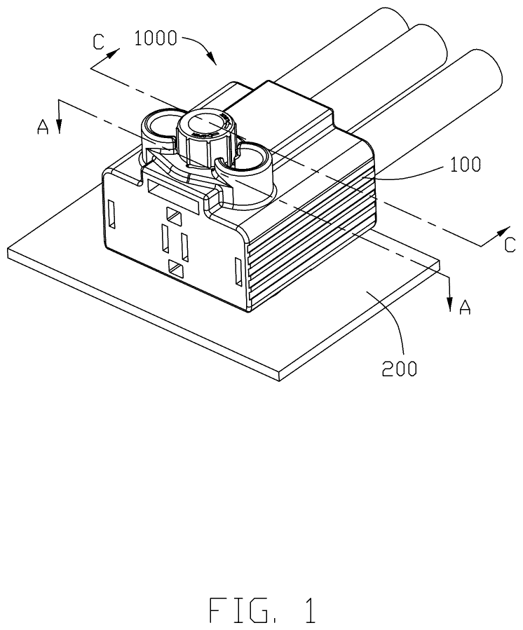

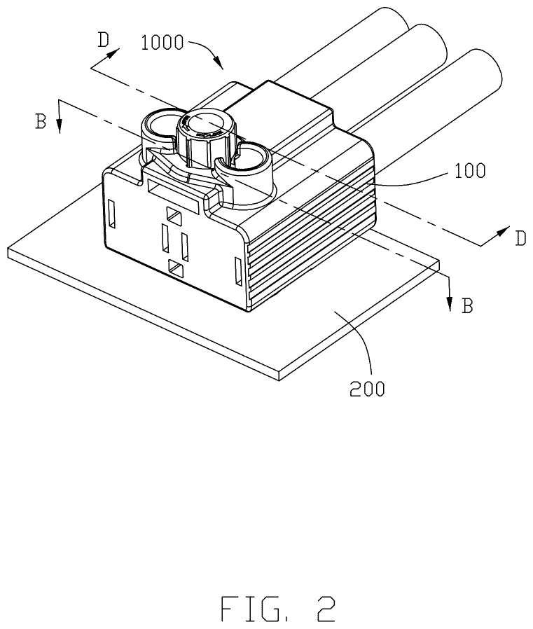

FIGS. 1-10 show an electrical connector assembly 1000 of the present invention. The electrical connector assembly 1000 includes a cable-end connector 100 and a board-end connector 200 mating with the cable connector 100. The cable connector 100 includes a housing 110, a terminal 120 disposed in the housing, a cable 130 extending along a first direction and connected with the terminal 120, and a latch 140 disposed in the housing 110. The cable-end connector 100 is configured to be lockably connected to the board-end connector 200 by the latch 140. As shown in FIGS. 1, 7, and 9, the cable-end connector 100 is lockingly connected to the board end connector 200. In this embodiment, the cable-end connector 100 is provided with a pair of terminals 120, including a first terminal 121 and a second terminal 122. Correspondingly, the board-end connector 200 is provided with a pair of mating terminals 210, including a first mating terminal 211 mating with the first terminal 121 and a second mating terminal 212 mating with the second terminal 122. It can be known that, in other embodiments, the cable-end connector 100 and the board-end connector 200 may have more or fewer terminals and mating terminals. That is, the number of terminals of cable-end connector and the board-end connector may be set according to the specific power or current to be transmitted.

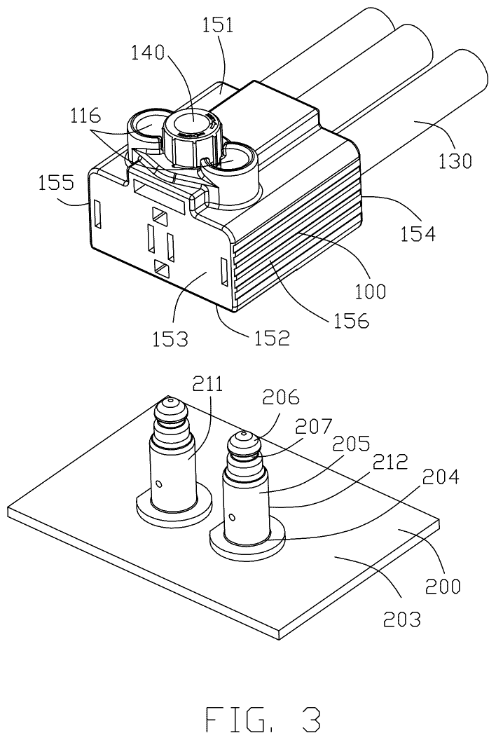

Referring to FIG. 3, the board-end connector 200 includes a substrate 203 holding the first mating terminal 211 and the second mating terminal 212, and the first mating terminal 211 and the second mating terminal may be connected to the substrate 203 by press-fit connection or by screws. In this embodiment, the substrate 203 is a circuit board. In other embodiments, the substrate 203 may also be a bus bar. The first mating terminal 211 and the second mating terminal 212 each includes a connecting portion 204 connecting to the substrate 203, a mating end 205 connecting to the terminal 120, and an extending end 206 extending from the mating end 205 in a direction away from the connecting portion 204. The extending end 206 is provided with an inwardly recessed groove 207, and the groove 207 is formed to engage with the latch 140 to lock the board-end connector 200 with the cable-end connector 100.

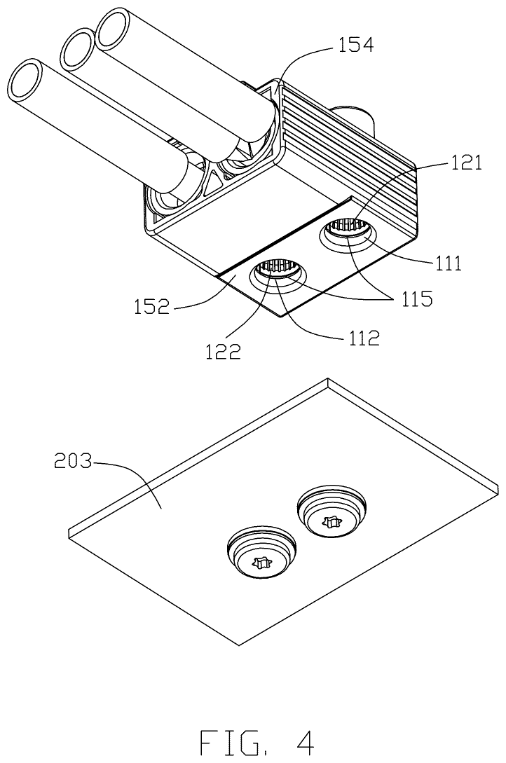

Referring to FIGS. 3-4, the housing 110 includes a top portion 151, a bottom portion 152, a front portion 153, a rear portion 154, a first side wall 155, and a second side wall 156. The first side wall 155 and the second side wall 156 are each disposed between the top portion 151, the bottom portion 152, the front portion 153, and the rear portion 154. The housing 110 includes a first cavity 111 and a second cavity 112 for accommodating the first terminal 121 and the second terminal 122, respectively, and a latch accommodation space 113 communicating with the first cavity 111 and the second cavity 112. The first cavity 111 and the second cavity 112 extend along a second direction perpendicular to the first direction and are separated by a partition wall 114 disposed in the housing 110. The bottom portion 152 is provided with a pair of bottom openings 115 in fluid communication with the first cavity 111 and the second cavity 112 respectively. The first mating terminal 211 and the second mating terminal 212 can respectively enter the first cavity 111 and the second cavity 112 through the pair of bottom openings 115 to be electrically connected with the corresponding terminals. The top portion 151 is provided with a pair of top openings 116. The first cavity 111 and the second cavity 112 are each communicated with the latch accommodating space 113 and communicate respectively with the upper openings 116. The rear 154 is provided with a pair of rear openings 117 in communication with the first cavity 111 and the second cavity 112 and through which the cable 130 can extend out.

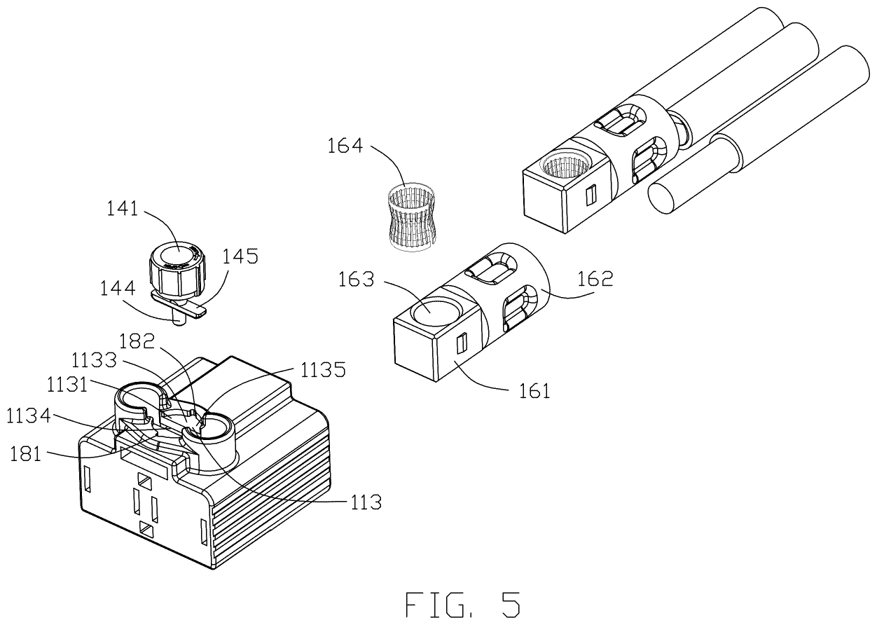

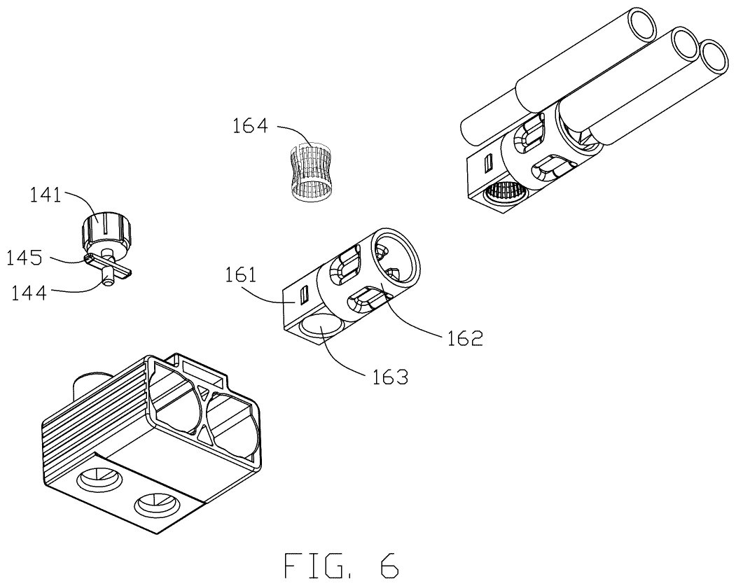

Referring to FIGS. 5-6, the first terminal 121 and the second terminal 122 each include a mating end 161 connected to mating terminal, and a connecting end 162 connected to the cable 130. The mating end 161 includes a hole 163, and a crown spring terminal 164 disposed in the hole 163. The first mating terminal 201 and the second mating terminal 202 respectively enter the corresponding hole 163 and connect to the crown spring terminal 164.

Referring to FIGS. 5-10, the latch 140 is unlocked and locked with the mating terminal by rotating clockwise and counterclockwise, respectively. Specifically, in this embodiment, the latch accommodating space 113 includes a first accommodating space 1131, a second accommodating space 1132 disposed in the housing, and a partition plate 1133 between the first accommodating space 1131 and the second accommodating space 1132. The first accommodating space 1131 includes a receiving portion opening 1135 opening upward from top portion 151. The receiving portion opening 1135 is disposed between the pair of top openings 116 and communicates with the pair of top openings 116. The latch 140 includes a substantially cylindrical knob 141, an extension portion 144 extending from the knob 141 into the housing 110, and a latch arm 145 extending from the extension portion 144 and capable of engaging the mating terminal. The knob 141 includes a knob portion 142 exposed to the first accommodating space 1131 and a limiting portion 143 coupled to the housing 110 to limit the position of the latch 140. The limiting portion 143 includes a first protrusion 171 and a second protrusion 172 extending radially outward from the knob 141. The first accommodating space 1131 is symmetrically provided with a recessed structure along the first direction for limiting the first protrusion 171 and the second protrusion 172, and includes a first receiving portion 181 and a second receiving portion 182. The partition plate 1133 is provided with a slot 1134, and the slot 1134 is connected to the first cavity 111 and the second cavity 112. The extension portion 144 and the latch arm 145 extend from the slot 1134 into the second accommodating space 1132 and are received in the second accommodating space 1132. The extension portion 144 extends downward from the second accommodating space 1132 into the partition wall 114. The partition wall 114 is provided with a notch 1136 for receiving a portion of the extension portion 144. The latch arm 145 includes a first arm 146 engaging the first contact terminal 121 and a second arm 147 engaging the second contact terminal 122. The first arm 146 and the second arm 147 are perpendicular to the extending portion 144 and are symmetrically arranged about the extending portion 144.

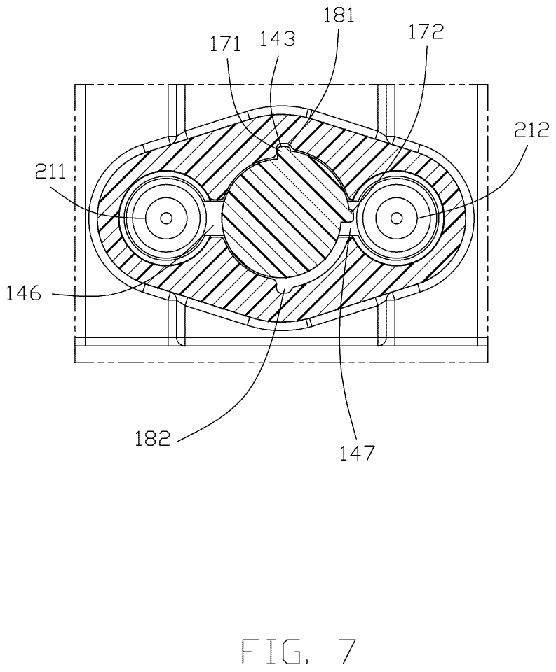

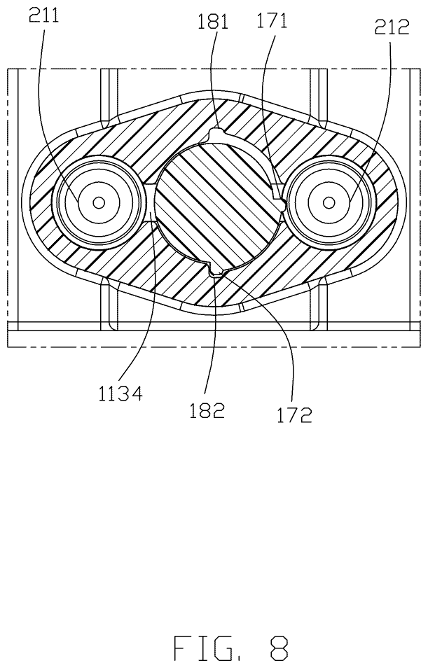

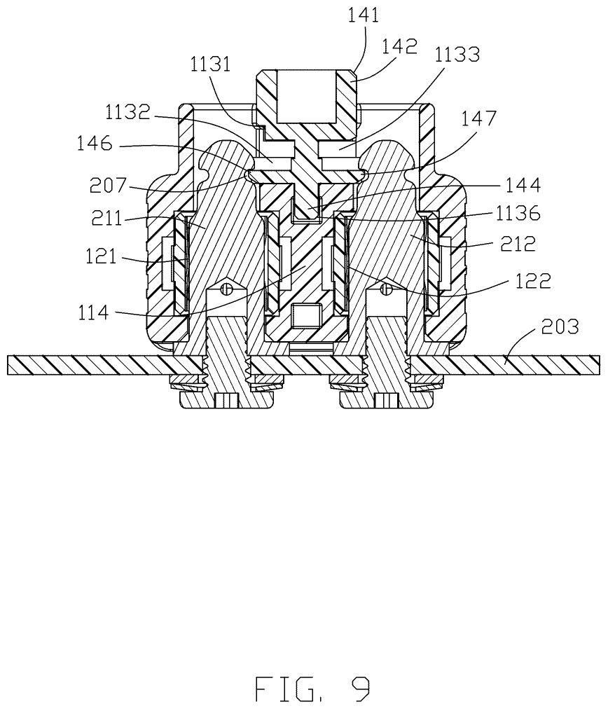

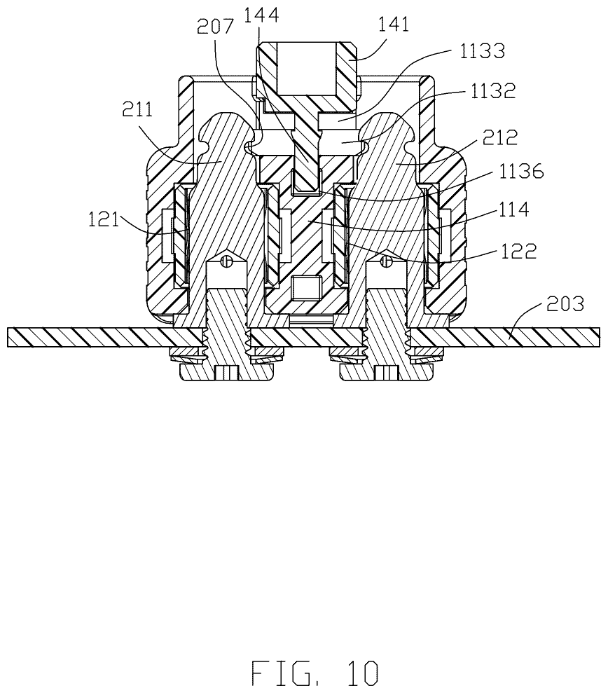

As shown in FIGS. 7 and 9, when the latch 140 is in the locked position, the first arm 146 engages the groove 207 of the first mating terminal 211, the second arm 147 engages the groove 207 of the second mating terminal 212, the first protrusion 171 is limited to the first receiving portion 181, and the second protrusion 172 is located in the slot 1134. As shown in FIGS. 8, and 10, when the latch moves from the locked position to the unlocked position, the knob portion 142 is rotated clockwise, and the first arm 146 and the second arm 147 are driven to rotate and release the corresponding mating terminal 210, and the first protrusion 171 moves out of the first receiving portion 181 and moves into the narrow groove 1134, and the second protrusion 172 moves to the second receiving portion 182 and is confined in the second receiving portion 182. At this time, the cable-end connector 100 can be removed from the board-end connector 200 without any hindrance. On the contrary, when the latch moves from the unlocked position to the locked position, the knob portion 142 is rotated counterclockwise, and the first arm 146 and the second arm 147 are driven to rotate until they engage the corresponding groove 207 of the mating terminal, and the second protrusion 172 moves from the second receiving portion 182 and moves to the slot 1134, and the first protrusion 171 moves to the first receiving portion 181 and is confined in the first receiving portion 181. At this time, the cable-end connector 100 and the board-end connector 200 are locked together reliably and stably.

The cable-end connector in the present invention realizes a more reliable and stable connection with the board-end connector through the design of the latch structure, thereby ensuring the safety and stability of power transmission.

1. An electrical connector comprising:
a cable extending along a first direction;
a terminal connected to the cable;
a housing comprising:
a top portion, a bottom portion, and a first side wall and a second side wall between the top portion and the bottom portion;
a cavity receiving the terminal and extending along a second direction perpendicular to the first direction, the bottom portion comprising an opening in fluid communication with the cavity for a mating terminal of a mating connector to enter the cavity through the opening and be electrically connected to the terminal; and
a latch accommodating space in communication with the cavity; and
a latch movably received in the latch accommodating space and configured to engage the mating terminal in a locked position to lock the electrical connector with the mating connector, and to release the mating terminal in an unlocked position to unlock the electrical connector from the mating connector; wherein
the latch is unlocked and locked with the mating terminal by rotating clockwise and counterclockwise respectively.

2. The electrical connector as claimed in claim 1, wherein the latch comprises a knob portion, a limiting portion coupled to the housing to limit the position of the latch, and a latch arm for selectively engaging the mating terminal.

3. The electrical connector as claimed in claim 2, wherein the latch accommodating space comprises a first accommodating space, a second accommodating space for receiving the latch arm, and a partition plate disposed between the first accommodating space and the second accommodating space, the first accommodating space comprises an upwardly opening and is configured to conform to the shape of the knob portion, and the knob portion is partially received in the first accommodating space from the opening.

4. The electrical connector as claimed in claim 3, wherein the latch comprises a extension portion extending from the knob portion toward the second accommodating space, the partition plate comprises a slot, the extension portion extends into the second accommodating space through the slot, the latch arm horizontally extends from the extension portion to engage the mating terminal.

5. The electrical connector as claimed in claim 4, wherein the housing is provided with a notch, and the bottom end of the extension portion is received in the notch.

6. The electrical connector as claimed in claim 5, wherein the limiting portion comprises a first protrusion and a second protrusion arranged at the bottom of the knob portion, the first receiving portion is provided with a first receiving portion for limiting the first protrusion and a second receiving portion for limiting the second protrusion, when the latch moves from the unlocked position to the locked position, the knob portion is rotated counterclockwise, the latch arm is driven to rotate and engages the mating terminal in the cavity, the first protrusion is limited in the first receiving portion, and the electrical connector and the mating connector are locked together, when the latch moves from the locked position to the unlocked position, the knob portion is rotated clockwise, the latch arm releases the mating terminal at the same time, the first protrusion escapes from the first receiving portion, and the second protrusion moves and is limited in the second receiving portion, and the electrical connector can be removed from the mating connector without any obstruction.

7. An electrical connector comprising:
a cable extending along a first direction;
a first terminal and a second terminal connected to the cable;
a housing comprising:
a top, a bottom, and a first side wall and a second side wall between the top and the bottom;
a first cavity and a second cavity respectively accommodating the first terminal and the second terminal and extending along a second direction perpendicular to the first direction, the bottom comprising a pair of openings respectively in fluid communication with the first cavity and the second cavity for a pair of mating terminals of a mating connector to enter the first cavity and the second cavity through the pair of openings to be electrically connected to the first contact terminal and the second contact terminal; and
a latch accommodating space in communication with the first cavity and the second cavity; and
a latch movably received in the latch accommodating space and configured to engage the mating terminals in a locked position to lock the electrical connector with mating connector, and to release the mating terminals in an unlocked position to unlock the electrical connector from the mating connector; wherein
the latch is unlocked and locked with the mating terminals by rotating clockwise and counterclockwise respectively.

8. The electrical connector as claimed in claim 7, wherein the latch comprises a knob portion, a limiting portion coupled to the housing to limit the position of the latch, and a first arm and a second arm for selectively engaging the mating terminals.

9. The electrical connector as claimed in claim 8, wherein the latch accommodating space comprises a first accommodating space partially receiving the knob portion, a second accommodating space receiving the first arm and the second arm, and a partition plate disposed between the first accommodating space and the second accommodating space, the first accommodating space comprises a accommodating space opening which opens upward and is configured to conform to the shape of the knob portion, and the knob portion extends out of the accommodating space opening.

10. The electrical connector as claimed in claim 9, wherein the latch comprises a extension portion extending from the knob portion toward the second accommodating space, the partition plate comprises a slot, the extension portion extends into the second accommodating space through the slot, the first latch arm and the second latch arm extend horizontally from the extension portion in the second accommodating space and are respectively engaged to corresponding mating terminals.

11. The electrical connector as claimed in claim 10, wherein the housing is provided with a partition wall separating the first cavity and the second cavity, the partition wall is provided with a notch, and the bottom end of the extension portion is received in the notch.

12. The electrical connector as claimed in claim 11, wherein the limiting portion comprises a first protrusion and a second protrusion arranged at the bottom of the knob portion, the first receiving portion is provided with a first receiving portion for limiting the first protrusion and a second receiving portion for limiting the second protrusion, when the latch moves from the unlocked position to the locked position, the knob portion is rotated counterclockwise, the first arm is driven to rotate and engages the mating terminal in the first cavity, and at the same time, the second arm is driven to rotate and engages another mating terminal in the second cavity, the first protrusion is limited in the first receiving portion, and the cable-end connector and the board-end connector are locked together, when the latch moves from the locked position to the unlocked position, the knob portion is rotated clockwise, the first arm and the second arm simultaneously release the mating terminals at the same time, the first protrusion escapes from the first receiving portion, and the second protrusion moves and is limited in the second receiving portion, and the cable-end connector can be removed from the board-end connector without any hindrance.

13. The electrical connector as claimed in claim 9, wherein the first cavity and the second cavity extend along the second direction to the latch accommodating space and continue upward to communicate with the top of the housing to form a pair of top openings.

14. The electrical connector as claimed in claim 13, wherein the accommodating space opening is disposed between the pair of top openings and in communication with the pair of top openings.

15. The electrical connector as claimed in claim 7, wherein the rear of the housing is provided with a pair of rear openings in communication with the first cavity and the second cavity, and the cables pass through the rear openings respectively.

16. An electrical connector assembly comprising:
a board-end connector comprising a first mating terminal, a second mating terminal, and a substrate holding the first mating terminal and the second mating terminal; and
a cable-end connector mating with the board-end connector, comprising:
a cable extending along a first direction;
a first terminal and a second terminal connected to the cable;
a housing comprising:
a top portion, a bottom portion, and a first side wall and a second side wall between the top portion and the bottom portion;
a first cavity and a second cavity respectively accommodating the first terminal and the second terminal and extending along a second direction perpendicular to the first direction, the bottom portion comprising a pair of openings respectively in fluid communication with first cavity and the second cavity, the first mating terminal and the second mating terminal respectively entering the first cavity and the second cavity through the pair of the openings to be electrically connected to the first contact terminal and the second contact terminal; and
a latch accommodating space in communication with the first cavity and the second cavity; and
a latch movably received in the latch accommodating space and configured to engage the first mating terminal and the second mating terminal in a locked position to lock the cabler-end connector with the board-end connector, and to release the first mating terminal and the second mating terminal in an unlocked position to unlock the cable-end connector from the board-end connector; wherein the latch is unlocked and locked with the first mating terminal and the second mating terminal by rotating clockwise and counterclockwise respectively.

17. The electrical connector assembly as claimed in claim 16, wherein the substrate is a circuit board, the first mating terminal and the second mating terminal each comprise a connecting portion connecting to the circuit board, a mating end connecting to the terminal of the cable-end connector, and an extending end extending from the mating end in a direction away from the connecting portion, the extending end is provided with an inwardly recessed groove, and the groove is formed to engage the latch.

18. The electrical connector assembly as claimed in claim 17, wherein the latch comprises a knob portion, a limiting portion coupled to the housing to limit the position of the latch, and a first latch arm and a second latch arm respectively engaging the grooves of the first mating terminal and the second mating terminal.

19. The electrical connector assembly as claimed in claim 18, wherein when the latch moves from the unlocked position to the locked position, the knob portion is rotated counterclockwise, the first arm is driven to rotate and engages the groove of the first mating terminal in the first cavity, and at the same time, the second arm is driven to rotate and engages the groove of the second mating terminal in the second cavity, and the cable-end connector and the board-end connector are locked together; when the latch moves from the locked position to the unlocked position, the knob portion is rotated clockwise, the first arm and the second arm simultaneously leave and release the first mating terminal and the second mating terminal, and the cable-end connector can be removed from the board-end connector without any hindrance.

20. The electrical connector assembly as claimed in claim 16, wherein the substrate is a bus bar.
